(19) United States
(12) Patent Application Publication
(10) Pub. No.: US 2026/0220098 A1
(43) Pub. Date: Jul. 30, 2026

(54) Schema Layering

(71) Applicant: Salesforce, Inc., San Francisco, CA (US)

(72) Inventors: David Gershuni, Carmel, IN (US); Simon Y. Wong, San Carlos, CA (US); Randy Philip Spalten, Benicia, CA (US); Nithya Muthukrishnan, Fremont, CA (US)

(21) Appl. No.: 19/038,905

(22) Filed: Jan. 28, 2025

(51) Int. Cl. G06F 16/21

(52) U.S. Cl. CPC G06F 16/213

(57) ABSTRACT

Techniques are disclosed for maintaining a database storing application data in a schema using schema layering. In some embodiments, a database system receives, from an instance of an application during the maintaining, a request to access application data stored in the database. The system may access schema overlays prior to accessing a base schema layer of the schema, where recent versions of objects stored in the schema overlays take precedence over corresponding prior versions of the objects stored in the base schema layer. After accessing the schema overlays, the system may access the base schema layer to retrieve objects that are not included in the schema overlays. The system may transmit, to the instance of the application, a notification indicating results of accessing the objects stored in the one or more schema overlays and the base schema layer.

### BACKGROUND

### Technical Field

This disclosure relates generally to databases, and, more specifically, to implementing schema layering for database schemas storing application data in database objects.

### Description of the Related Art

For efficiency, applications often rely on a database management system (DBMS), such as a relational database management system (RDBMS) to store user-defined code, which includes objects such as functions, view, types, procedures, modules, etc. that can be executed in a database implemented by the RDBMS. These user-defined objects are collectively referred to as a schema. The number of user-defined objects necessary for a full deployment of an application can be vast, often involving hundreds of thousands of objects, for example. Moreover, an application may need to load multiple clones of the user-defined code, with minor variations, such that new deployments of the application can be executed with zero downtime (ZDT). For example, if a first version of an application is updated, a copy of the first version (including all of the user-defined objects used to implement this first application version) is generated by the database management system in order to deploy a second, altered version of the application while the first version of the application is still running. That is, in order to execute a ZDT deployment of a new version, an application typically cannot modify the system in place and, therefore, must create a copy of various database objects utilized by the application before deploying the new version to avoid affecting the application version currently in use. In addition to the multiple versions of an application requiring multiple copies of user-defined objects, database management systems commonly store additional copies of the user-defined objects that make up an application for emergency deployments, rolling back to previous deployments, convenience (e.g., one copy for each day of the week for ease of deployment separation), etc. The need for schema code copies can lead to greater storage requirements, which is generally both computationally and financially expensive.

### BRIEF DESCRIPTION OF THE DRAWINGS

FIG. 1 is a block diagram illustrating an example system configured to execute a database management system for implementing schema layering for application instances, according to some embodiments.

FIG. 2 is a block diagram illustrating an example schema, according to some embodiments.

FIG. 3 is a block diagram illustrating an example system catalog, according to some embodiments.

FIG. 4A is a block diagram illustrating example data definition language (DDL) scripts, according to some embodiments.

FIG. 4B is a block diagram illustrating an example fingerprint table generated from the DDL scripts of FIG. 4A, according to some embodiments.

FIG. 4C is a block diagram illustrating an example function catalog table and layer catalog table corresponding to the fingerprint table of FIG. 4B, according to some embodiments.

FIGS. 5A and 5B are block diagrams illustrating example implementation of database queries from different schema layers, according to some embodiments.

FIG. 6 is a flow diagram illustrating a method for handling application requests from a database implemented using schema layers, according to some embodiments.

FIG. 7 is a flow diagram illustrating a method for generating schema layers for a database schema, according to some embodiments.

FIG. 8 is a block diagram illustrating elements of a multi-tenant system, according to some embodiments.

### DETAILED DESCRIPTION

Databases store lots of user-defined code that includes database objects such as procedures, modules, types, views, etc. and this code must be stored in the database so that it is executable on the data stored in the database without having to move the data stored by the database to an application executing on an end user device, for example. Moreover, applications often need to load multiple copies of a set of user-defined code (where each of the multiple copies includes minor variations), such that new deployments of the user-defined code are executable with zero downtime. For example, the disclosed database stores 100,000 functions in a given schema for an application and the database is loading a new version of the application for release the following day (e.g., on Tuesday), but this release changes only one of these 100,000 functions. Traditionally, the database system would load a copy of all 100,000 functions for the new application version release, even though only one of the functions is changing. This cumbersome load of all 100,000 functions is slow and inefficient. Along with loading these 100,000 functions for an additional, new version of the application, the database needs to store two copies of these 100,000 functions (one copy for the first application version and one copy for the second application version). These additional copies of application code introduce a burden on the database in terms of storage capacity requirements, for example. Further, if a database system makes an update to the database, then each object stored in the database catalog needs to be updated and transformed. In the example above, the 200,000 functions would need to be updated and transformed, which increases the computational cost of maintaining the database.

In general, new versions of a given application are deployed periodically (e.g., on a daily, weekly, monthly, etc. basis), allowing for quick and frequent rollout of new features as well as resolution of software defects. Application versions, which include the code for the application, are generally stored in a database using objects. These objects store application data and do not store end user data, which allows for easy loading and alteration in an on-demand manner using structure query language (SQL) scripts. As discussed above. Application source code changes are performed by a database management system using schemas. For example, different versions of the application code can be deployed to multiple schemas in parallel without the need to change the application code based on the current deployment of the application. Daily release of a copy of the latest application code may be performed by the database system using a schema dedicated for a given day of the week. As discussed above, however, the storage needs of multiple schemas are often cumbersome and expensive.

As used herein, the term “schema” is intended to be construed according to its well-understood meaning in the context of a database implemented according to a structured query language (SQL), which includes a set of database objects that are grouped together logically in a namespace For example, a schema in the context of databases includes a structure of the database, which includes tables, indexes, views, types, functions, etc. In this example, a database's schema refers to its structure as opposed to the data that it stores (i.e., the content of the database). For example, SQL schemas are used to create separate namespaces for each department at a company such that each department can name their objects freely without concern of using a name chosen by another department. As another example, SQL schema can be used to store multiple versions of the same SQL objects such that newer object versions can be created without modifying the prior versions. The disclosed techniques provide a unique solution in the context of managing an evolving set of database objects that are versioned by storing different versions of the set of database objects in multiple schemas, where each subsequent version of the set of database objects largely matches the prior version.

As used herein, the term “namespace” is intended to be construed according to its well-understood meaning, which includes a folder that groups things together and allows for creation of unique names for the things within the group. In disclosed techniques, a collection of database objects (such as tables) that are included in a “namespace” (a folder) may be referred to herein as schemas. For example, each namespace in a database may group together a separate collection of relations, types, views, functions, etc. without introducing name conflicts with a collection of relations, types, view, functions, etc. grouped in another namespace. As one specific example, a first schema is one example of a namespace that contains a set of named database objects (e.g., tables, data types, functions, operators, etc.) whose names can duplicate those of other objects existing in other schemas. In this specific example, a second schema is a separate namespace that can include a copy of the database objects in the first schema and the objects in the second schema can be assigned the same names as corresponding objects in the first schema without introducing naming conflicts. This duplicate naming construct is enabled due to the fact that the objects exist in separate namespaces.

To combat the increasing storage and computational needs of maintaining multiple different database schemas storing user-generated database objects (e.g., corresponding to different versions of an application), the disclosed techniques implement schema layering. For example, instead of generating an entirely new copy of a schema and then implementing the differences each time an application version is updated, a schema layer stores only the differential of database objects relative to a base schema. A base schema includes a complete snapshot of user-defined database objects at a given point in time as created by a user-provided DDL script. When a change is made to one or more objects, the disclosed system generates a new schema layer (referred to herein as an overlay) that includes a new version of only the one or more database objects that were changed, added, or deleted. In the common case in which a schema contains many thousands of objects and only a small fraction of them change from one version to the next, schema layering offers a significant increase in storage efficiency. If the application corresponding to this schema implements nine different versions, for example, implementing the disclosed schema layering for this application may reduce the overall catalog size by approximately 80% to 90%, since the total number of stored objects shrinks from about 9× to 1×. This in turn, will advantageously reduce the overall storage requirements and computing resources needed to maintain and implement the application.

In disclosed techniques, schema layering includes generating two or more layers, beginning with a base schema layer and then continuing with any number of overlay schema layers depending on the application and its various versions (which may increase over time). In various embodiments, the overlay schema layers for an application include changes relative to the base schema layer (not relative to the previous overlay schema). These layers may be generated periodically, e.g., on an hourly, daily, weekly, monthly, etc. basis. As one example, overlay schemas may be generated from a base schema layer, where a base schema layer has three different overlay schema layers: Monday, Tuesday, and Wednesday. In this example, the base schema includes two views, V1 and V2, and the Monday overlay is empty (i.e., no changes were made on Monday to the base schema). Further in this example, the Tuesday overlay includes a new view, V3, and an updated version of view V1, while the Wednesday overlay includes the new V3, the updated version of V1, and negative entry for V2 (i.e., view V2 has been deleted in the application version corresponding to the Wednesday overlay). In this example, a negative entry for the deleted view, V2, is included in the Wednesday overlay to indicate that V2, which exists in the base schema, has since been deleted. Thus, queries requesting to retrieve V2 on Wednesday or later will return a null value.

In disclosed techniques, tables will typically not be included in schema layers. For example, unless the size of a table is small (e.g., includes a hundred rows), it is unlikely that the disclosed system will include it in a schema layer. Generally, database tables store millions or billions of rows of data, and this amount of data would be too cumbersome to copy from one schema layer to the next. For this reason, the disclosed techniques store views in a schema layer instead of tables. For example, schema layering is suited well for database objects that do not directly store persistent data (e.g., tables). While the disclosed techniques do not exclude the use of schema layering on persistent database objects, schema layering is more often used for metadata objects, such as views, types, functions, procedures, etc.

### Example Database Management System

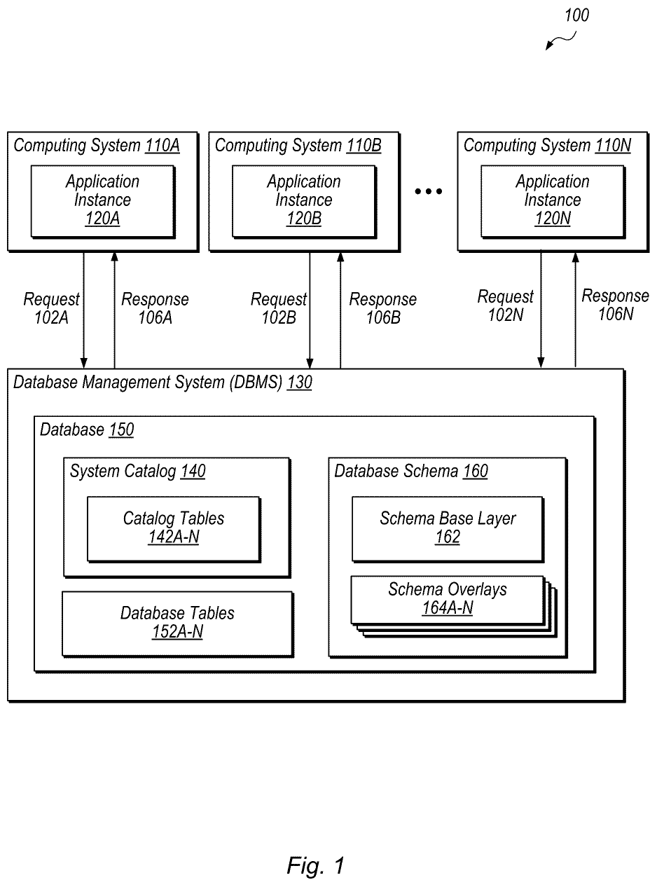

FIG. 1 is a block diagram illustrating an example system configured to execute a database management system for implementing schema layering for different applications instances. In the illustrated embodiment, system 100 includes computing systems 110A-110N and database management system (DBMS) 130 configured to communicate for processing application requests. In the illustrated embodiment, DBMS 130 includes database 150, which in turn includes system catalog 140, database table 152A-152N, and database schema 160.

Computing systems 110A-110N, in the illustrated embodiment, include application instances 120A-120N, respectively. These instances 120A-120N are different occurrences or executions of a given application 120 for which DBMS 130 stores and manages data. Accordingly, computing systems 110A-110N may be application servers configured to facilitate use of the application 120, that includes various instances 120A-120N, by various users. In some embodiments, DBMS 130 is a customer relationship management system that manages applications for various customers. For example, the application may be Salesforce. com™, different instances 120A-120N of which are executing via web browsers or mobile applications on computing systems 110A-110N. In some situations, different users (of the same or different customers) utilize the same application, but implement different versions of this application. For example, DBMS 130 may manage a software development application (such as a software development tool) for two different users, but each user implements a different version of the software development application with access to different data maintained by DBMS. As shown in the illustrated embodiment, each of computing systems 110A-110N are executing a different instance 120A-120N of a given application. In other embodiments, computing systems 100A-110N execute instances of two or more different applications.

In the illustrated embodiment, computing systems 110A-110N send requests 102A-102N, respectively, to DBMS 130 for application instances 120A-120N. These requests 102A-102N may be queries that request access to various data stored in database 150 and specify a particular application version (e.g., that corresponds to the versions of the application currently executing on computing systems 110A-110N). In some embodiments, request 102A, submitted by computing system 110A for application instance 120A, specifies a first application version which corresponds to the current version of application 120 executing on computing system 110A. Request 102A is a request to access application data that is stored by database 150 and corresponds to the version of application 120 executed at computing system 110A via application instance 120A.

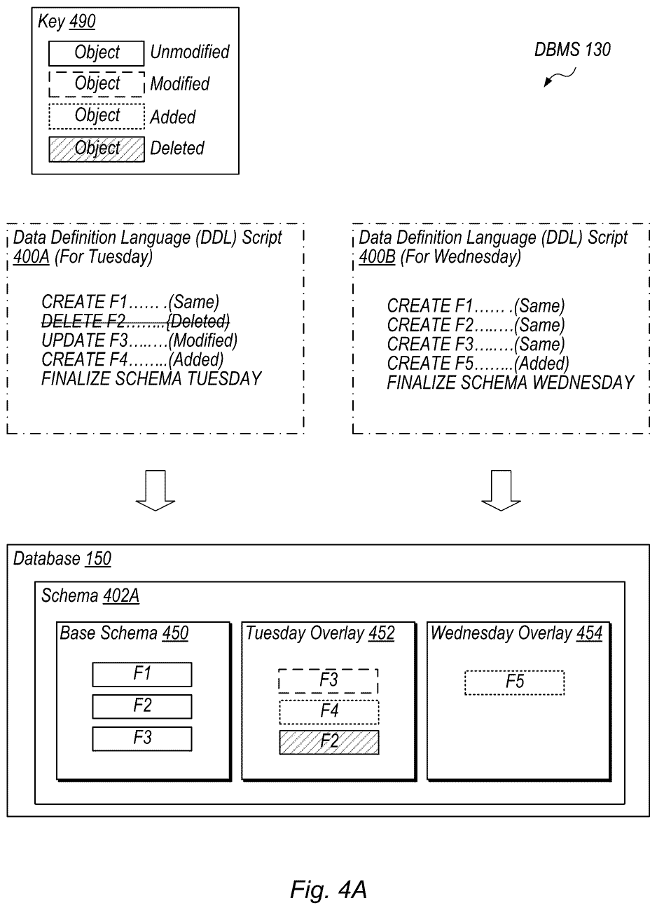

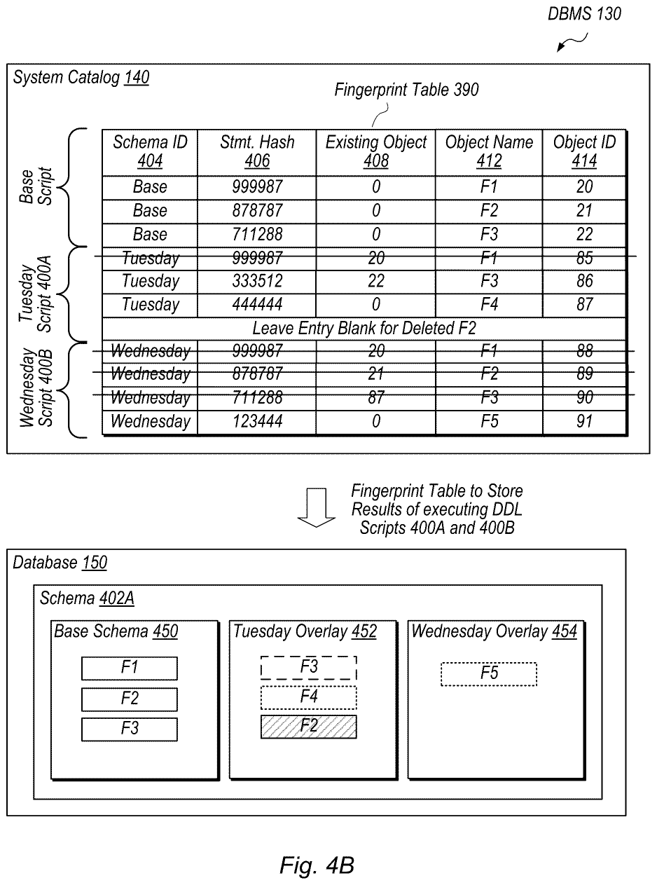

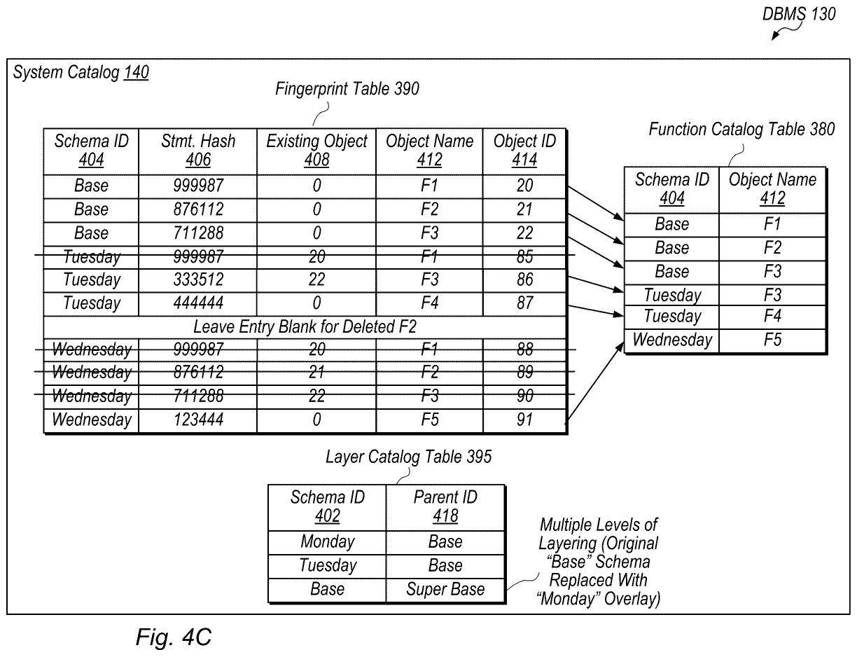

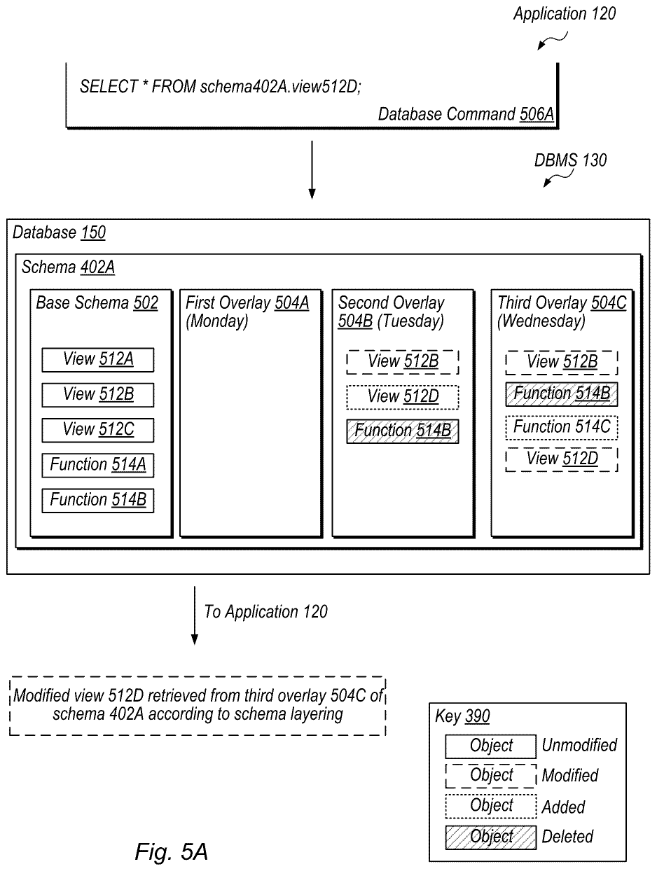

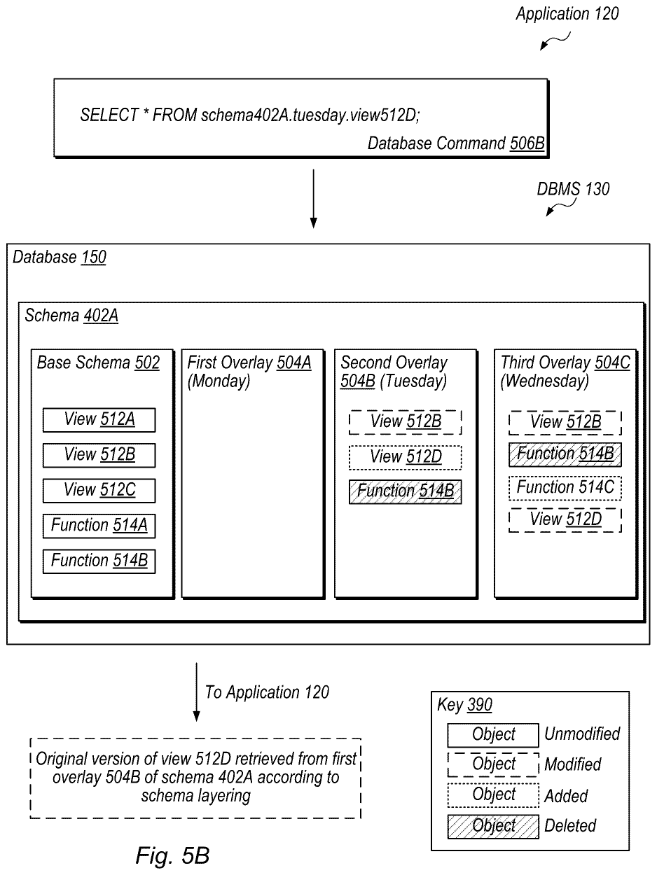

In some embodiments, request 102A is a request to create or manipulate application data stored by database 150 for application 120. For example, request 102A may include one or more data definition language (DDL) commands, such as a DDL command to create a database object, modify a database object, or delete a database object. Example DDL commands are discussed in further detail below with reference to FIG. 4A. In other embodiments, request 102A is a request to read application data stored by database 150 for application 120. For example, request 102A may include a query to select a database object from which to read data as shown in FIGS. 5A and 5B. In various embodiments, DBMS 130 sends responses 106A-106 to requests 102A-102N, respectively. For example, a response 106A includes a notification specifying that one or more requested database operations specified in request 102A have been performed to alter the application data of application 120 and its corresponding schema (via schema layers as discussed in further detail below with reference to FIGS. 4A-6). As another example, a response 106B includes a notification indicating that a requested database object specified in request 102B is unavailable or that this object no longer exists in the database due to DBMS 130 identifying that this object includes a negative entry in a schema overlay, as discussed in further detail below with reference to FIG. 4A.

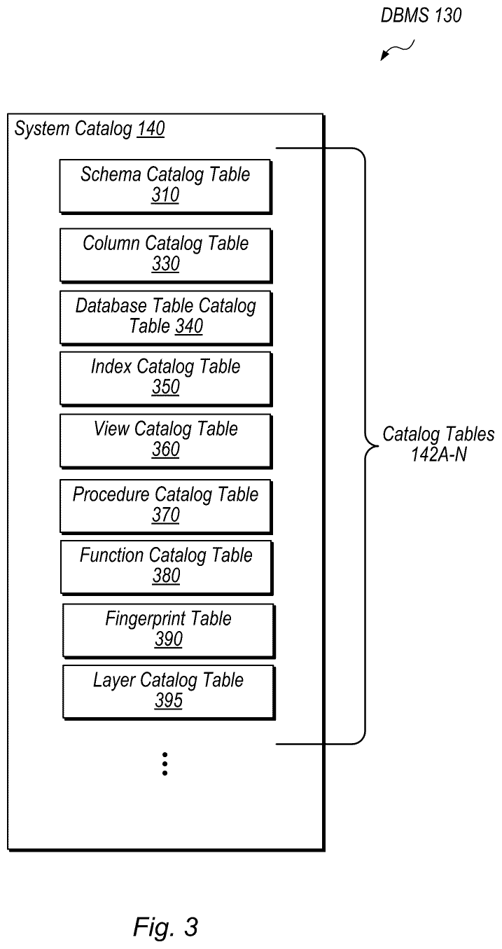

In the illustrated embodiment, database 150 stores user data in a plurality of database tables 152A-152N. In addition to storing user data in tables 152A-152N, database 150 also stores application data for various applications and their respective different versions in a plurality of database schemas, such as database schema 160. In the illustrated embodiment, database 150 stores system catalog 140, which is a collection of catalog tables 142A-142N that include information about data stored in database 150. This information is often referred to as metadata which specifies details about the user data stored by e.g., database tables 152A-152N and or application data stored by database schema 160. In various embodiments, system catalog 140 stores metadata about the application data for different versions of application 120, which correspond to database schema 160 stored in database 150. In other embodiments, database 150 also stores multiple different database schemas for various applications other than application 120. Example catalog tables 142A-142N stored by system catalog 140 are discussed in detail below with reference to FIG. 3.

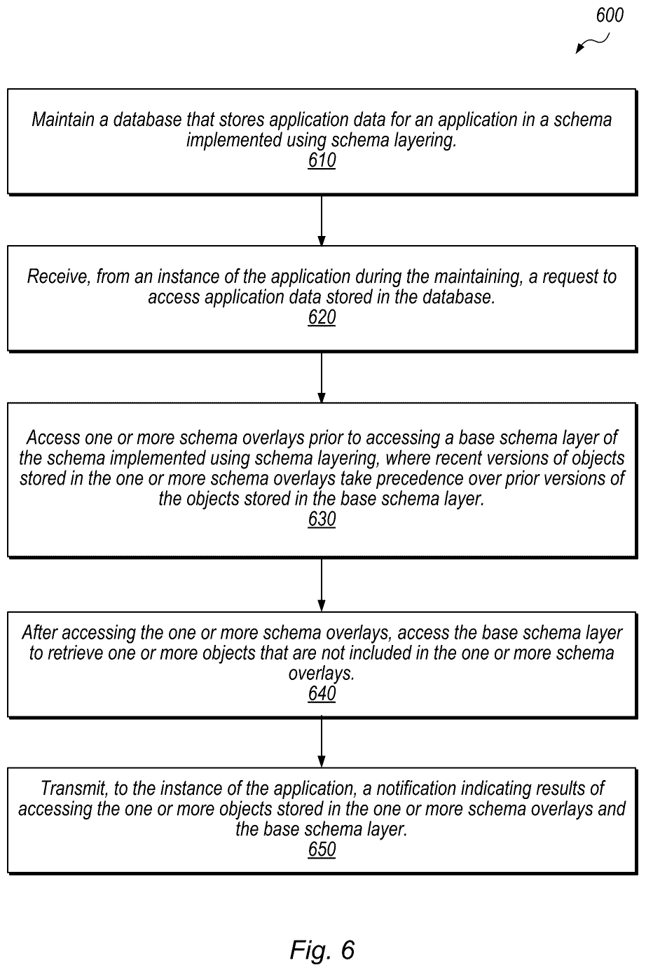

As used herein, the term “system catalog” is intended to be construed according to its well-understood meaning, which includes a portion of a database that stores metadata about the data stored in the database such as schemas defining database objects. For example, the system catalog may include various catalog tables or catalog views. These catalog tables may include metadata describing data stored in various objects included in the database managed by the DBMS, such as database: tables, columns, triggers, indexes, statistics, procedures, views, etc. These catalog tables may be used to determine the best way to evaluate a structured query language (SQL) query received from an application, for example. The terms “catalog” and “catalog table” may be used interchangeably. In the present disclosure, the catalog tables specify subsets of a dataset stored in the database that are accessible to different applications versions, including which database tables are visible to certain applications. As used herein the term “metadata” is intended to be construed according to its well-understood meaning, which includes a set of data that describes other data. For example, metadata may be included in catalog tables of the system catalog stored in the disclosed database. Specifically, this metadata may specify an application version associated with a particular schema in the database. Example metadata stored in the system catalog is discussed in detail below with reference to FIGS. 4B, 4C, and 6.

As used herein, the term “application version” refers to a particular form of an application that differs from earlier or later forms of the application. For example, an application version may be assigned to a new or updated version of an application using a monotonically increasing numbering scheme, which governs the accessibility of various database content to different versions of an application. As one specific example, a first version of an application may be assigned version 1.1, while a second, later version of the application is assigned version 1.2. In disclosed techniques, each of these versions may correspond to a schema layer (e.g., application version 1.1 has application data stored in a base schema layer, while application version 1.2 has application data stored in a first schema overlay). Application instances, as shown in FIG. 1, are different instances of an application executing on the various computing systems. An application instance may be running a given version of a plurality of different versions of the application.

Database 150, in the illustrated embodiment, stores database schema 160 for application 120. This database schema 160 includes a schema base layer 162 and one or more schema overlays 164A-164N. Each of the schema base layer 162 and schema overlays 164A-164N correspond to a different version of application 120 (which in turn may correspond to different instances 120A-120N of application 120).

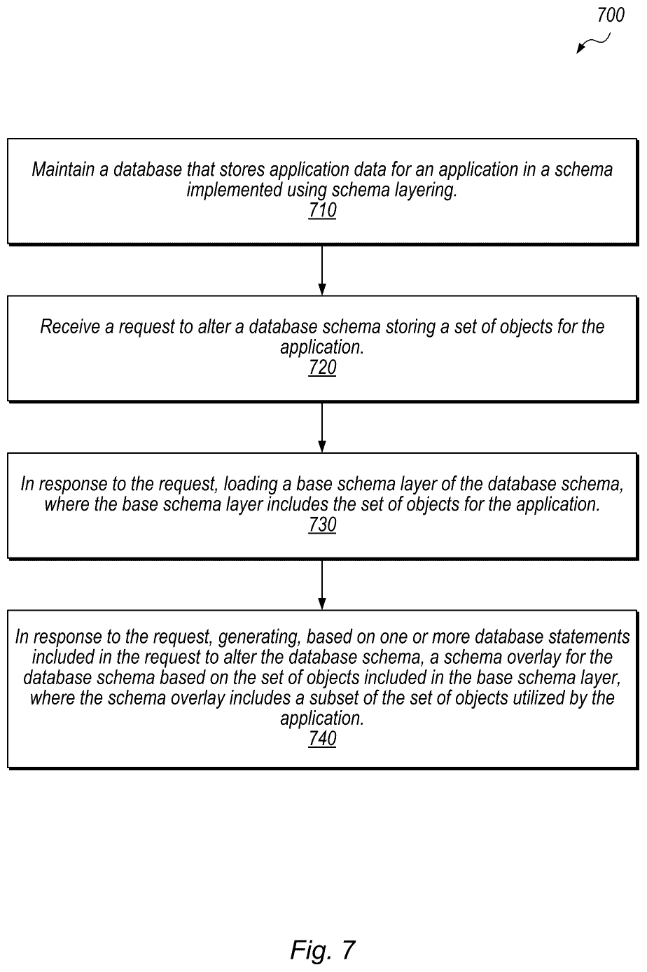

In some embodiments, in response to receiving requests 102A-102N, DBMS 130 accesses database 150 to retrieve data from database tables 152A-152N based on an application version of the application instances 120A-120N that submitted the respective requests. For example, application instance 120A is operating a first version of application 120 and submits request 102A to DBMS 130 to access application data stored in database schema 160. While not shown in FIG. 1, in various embodiments, database tables 152A-N each live in a schema. For example, a given schema may store zero or more tables. As discussed in further detail below, however, the disclosed techniques typically do not store database tables 152A-N in schemas that are being layered. DMBS 130 accesses one or more of schema overlays 164A-164N and schema base layer 162 of database schema 160 to read application data from one or more objects specified in request 102A and corresponding to a first version of application 120. Examples of accessing application data in database 150 in response to read requests 102A-102N are discussed in further detail below with reference to FIGS. 5A, 5B, and 7.

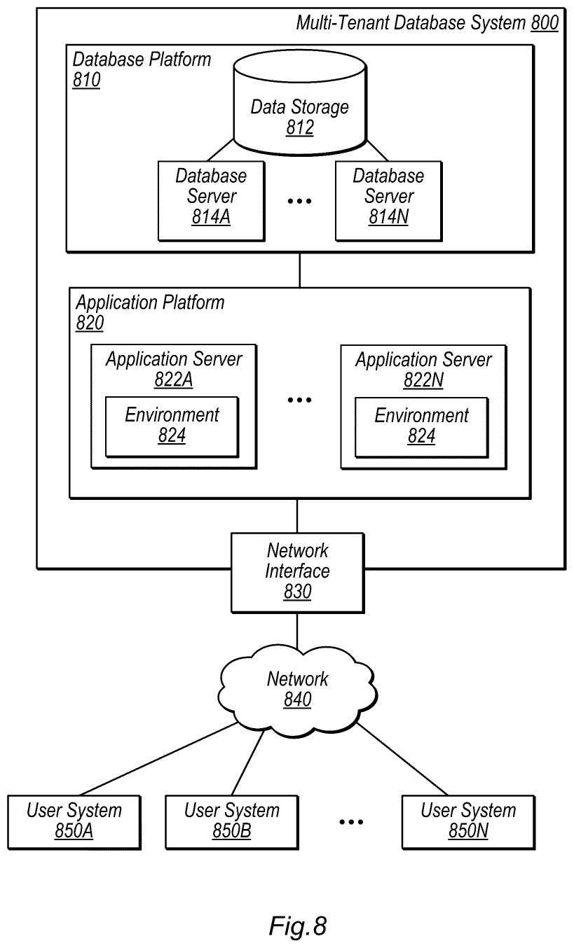

In other embodiments, in response to receiving requests 102A-102N, DBMS 130 accesses database 150 to manipulate application data stored in database schema 160 based on an application version corresponding to a respective request. As discussed in further detail below with reference to FIGS. 4A-4C and 8, in various embodiments, DBMS 130 receives requests to update or delete application data stored in database 150. Based on these requests, DBMS 130 manipulates application data, often by generating new application versions, and implementing schema layering for these new application versions.

Regardless of whether requests 102A-102N are requesting to read or to manipulate application data stored by DBMS 130, these requests may or may not specify an application version corresponding to application data they would like to access. In some embodiments, request 102A specifies an application version for requested data. In other embodiments, request 102A does not specify an application version for requested data. In embodiments in which request 102A does not specify an application version, a search path is utilized by DBMS to resolve unqualified object references (such as those included in request 102A). As used herein, a “schema-qualified reference” specifies an object to access by explicitly referencing the schema from which to retrieve that object. For example, the SQL statement “SELECT schema1.function2( )” references the function “function2” that exists in the schema “schema1.” Note that a schema-qualified references may also be referred to herein as a “qualified reference.” In contrast, an “unqualified reference” does not specify a particular schema in which to search for database objects. For example, the SQL statement “SELECT function2( )” references some function “function2,” but does not specify which schema to search in, leaving the object's resolution open to evaluation at execution time.

As used herein, the term “search path” is intended to be construed according to its well-understood meaning, which includes a list of schema names which are searched according to their specified order when a database management system is looking up objects stored in the database according to requests that include unqualified object references. For example, a search path is used by the disclosed database system to search for requested application data in terms of searching schemas when a request is received from an application instance to retrieve user-generated objects from the database. As one example, a search path “a,” “b,” “system” includes a list of schemas that informs the database system where to search for user-generated code if the end user (i.e., application) does not specify where to search for the data it is requesting. In this example, “system” is the name of a database system schema. Each of the schemas “a” “b” and “system” are stored in the same database, but within their own separate namespace.

The database system (e.g., DBMS 130) may receive the following qualified search query: select*from a.view1. In this example, “a” is the name of the schema from which to fetch the database objects and “view1” is the name of the database object the user is trying to access within schema “a.” In contrast to this qualified search query, the database system may receive an unqualified search query: select * from view1; this search query does not specify which schema to search in, so the system uses the search path which looks in schema “a” first. In various embodiments, the database system utilizes the search path to sequentially search each of the specified schema for the requested database objects. Eventually, if all schemas in the search path are checked and the object(s) are still not found, an error is thrown. In various embodiments, the search path is specific to each connection to the database (e.g., each computing system, such as systems 110A-110N) has its own search path and the user can reset their own search path, if desired. For example, the user can change the search path throughout the day, if they are working in a specific schema and want to switch to working in a different schema.

In various embodiments, the search path could include unqualified references in the form of the following example search path: “$user, system.” In this example, the search path entry, “$user,” dynamically refers to the schema whose name matches the name of the current user for this database connection. For example, when the user “u1” is connected to the database, the “$user” search path entry is translated to the schema “u1” (if it exists). A database client can take advantage of this fact by using a different database user each time it deploys a new set of database objects. By using the search path and unqualified references, different versions of an application can be deployed to multiple schemas in parallel without the need to change the application code based on the deployment. For example, an application may create a separate user and schema for each day of the week and then submit statements such as “select f( )” and the Monday code will automatically execute Monday.f( ) whereas the Tuesday code will execute Tuesday.f( ).

### Example Schema

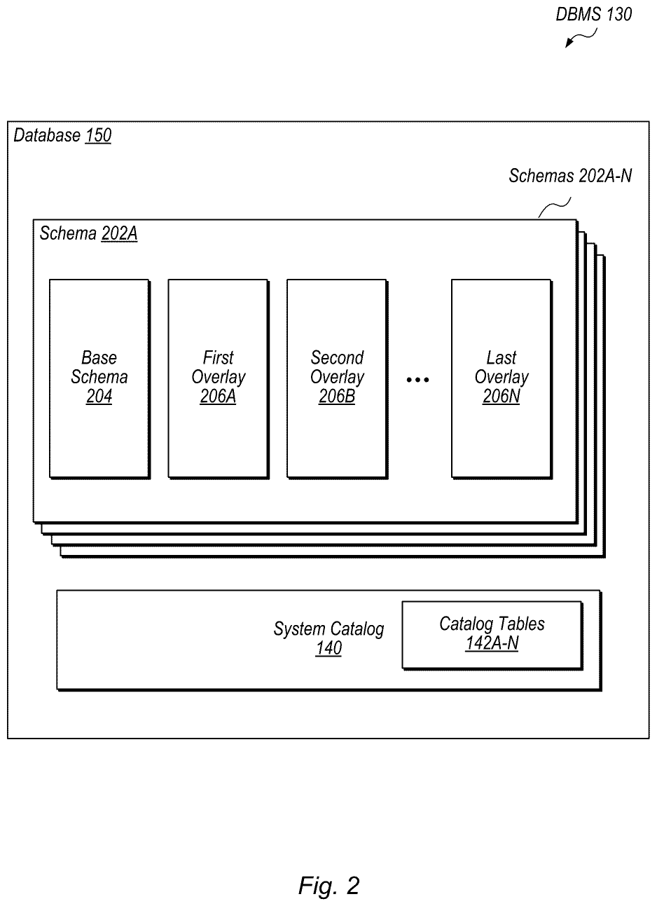

FIG. 2 is a block diagram illustrating an example schema. In the illustrated embodiment, database 150 includes a plurality of example schemas 202A-202N storing application data for a plurality of different applications. An example schema 202A is shown in the illustrated embodiment to include a base schema 204 and a plurality of different overlays (i.e., first overlay 206A, second overlay 206B,. last overlay 206N). Note that base schema 204 may also be referred to herein as a base schema layer.

In various embodiments, base schema 204 includes a set of database objects that make up a first version of an application. For example, if a first version of the application includes 10,000 functions, then these functions are stored in base schema 204. In various embodiments, first overlay 206A includes a subset of the set of database objects that have been altered from their original state in the first version of the application in order to generate a second version of the application. In some embodiments, first overlay 206A also includes one or more new database objects that were not included in the set of database objects stored in base schema 204. For example, first overlay 206A may include 100 updated functions of the 10,000 functions included in the base schema 204 as well as 50 new functions that were not included in base schema 204. In some embodiments, second overlay 206B includes 10 functions from the set of functions that have been deleted, and all of the changed objects from first overlay 206A. For example, each of overlays 206A-206N include a differential of database objects relative to base schema 204. Accordingly, second overlay 206B includes ten negative entries, indicating that the ten functions from the set of 10,000 functions in base schema 204 have been deleted in a third version of the application, the 100 updated functions and the 50 new functions. The DBMS 130 may continue to generate any number of schema overlays for an application as new versions of this application are generated. Example base schemas and schema overlays are discussed in detail below with reference to FIGS. 4A-6.

### Example System Catalog

FIG. 3 is a block diagram illustrating an example system catalog. In the illustrated embodiment, system catalog 140 includes examples of the plurality of catalog tables 142A-142N that store metadata for various user-defined database objects. Specifically, in the illustrated embodiment, system catalog 140 includes: a schema catalog table 310, a column catalog table 330, a database table catalog table 340, an index catalog table 350, a view catalog table 360, a procedure catalog table 370, a function catalog table 380, a fingerprint table 390, a layer catalog table 395, etc. While several examples of the types of catalog tables 142A-142N that may be included in system catalog 140 are shown in FIG. 3, any of various additional catalog tables may be stored by system catalog 140, in other embodiments.

Schema catalog table 310 stores information about various schemas maintained by DBMS 130 for various applications. Schema catalog table 310 may also be referred to herein as “namespace catalog table.” For example, schema catalog table 220 includes a schema identifier column, a schema name column, and a version identifier column for various schemas and their respective layers (base schema and overlays). In disclosed techniques, schema catalog table 310 includes a base schema column for schema layering that records, for each different schema overlay, an object identifier of a base schema for this schema overlay. In the example discussed above with reference to FIG. 2, the entry in the base schema column of schema catalog table 310 for first overlay 206A includes the object identifier of base schema 204. In situations in which a schema layer does not have a base layer, the object identifier value stored in the base schema column of schema catalog table 310 will be zero. As one specific example, schema catalog table 310 may be named “pg_namespace” and the column for schema layering may be named “nsp_base_schema.”

Column catalog table 330 and database table catalog table 340 store metadata specifying identifiers and versions of database tables 152A-152N stored in database 150 and of the various columns included in these tables, respectively. Index catalog table 350, view catalog table 370, procedure catalog table 370, and function catalog table 380 store metadata specifying information about various user-defined objects included in application data for a plurality of different applications.

Fingerprint table 390, in various embodiments, stores metadata that can be used to efficiently compute differentials indicating the differences between schema layers. In disclosed techniques, to efficiently compare a base schema layer of an application with overlay schema layers and incoming requests for database changes (e.g., data definition language (DDL) statements), DBMS 130 implements a fingerprint table, which stores a fingerprint of the statement that created each database object that is created in a base layer or overlay schema layer. An example fingerprint table is discussed in detail below with reference to FIGS. 4B and 4C.

In some embodiments, layer catalog table 395 stores metadata specifying information about schema layers of an application that has multiple levels of schema layering. In other embodiments, this multi-level schema layering information is stored in schema catalog table 310. For example, an application may be generated with an “original” base schema, which eventually is replaced by a “new” base schema. DBMS 130 implements this replacement when the number of changes (i.e., objects) included in a schema overlay relative to the original base schema becomes too large and prohibits quick and efficient database operations. For example, the number of objects specified in a schema overlay may be more than a layer object threshold. This threshold may specify a maximum number of objects allowed in a given schema overlay. If a schema overlay meets or exceeds this threshold, then DBMS 130 generates and labels a new base schema layer that incorporates the objects changes of the latest schema overlay that met the layer object threshold (and all previous schema overlays generated between the latest schema overlay and the base schema). Layer catalog table 395 tracks these base schema layers via a schema identifier and its corresponding parent identifier as discussed in further detail below with reference to FIG. 4C.

### Example Schema Layering

FIG. 4A is a block diagram illustrating example data definition language (DDL) scripts. In the illustrated embodiment, DBMS 130 executes two separate DDL scripts 400A and 400B on database 150. The illustrated embodiment further shows a key 490 indicating the different operations performed by DBMS 130 on database objects according to scripts 400A and 400B. Specifically, key 490 shows that an object that is unmodified (e.g., an original version of the object) is represented via a rectangle with solid lines, an object that has been modified is represented via a rectangle with long dashes, an object that has been added is represented via a rectangle with dotted lines, while an object that has been deleted is represented via a shaded rectangle. As shown in FIG. 4A, an object that has been added to a schema overlay is a new database object that did not previously exist in the base schema corresponding to this schema overlay.

Script 400A, in the illustrated embodiment, includes several separate commands to generate a “Tuesday” schema. DBMS 130 executes this script on a base schema 450 of schema 402A using schema layering techniques to generate a Tuesday overlay 452 for schema 402A. As discussed in further detail below with reference to FIG. 4B, DBMS 130 executes scripts 400A and 400B using a fingerprint table to implement schema layering (rather than generating an entirely new schema for schema 402A based on the scripts). Specifically, in the illustrated embodiment, script 400A includes DDL statements to create two different functions F1 and F4, and to update function F3. Since each script recreates an entire schema each time, a “delete” statement is affected by simply removing the statement from the script 400A to indicate that function F2 is deleted in this version of the schema. This removal of the DDL delete statement is shown as a strikethrough in FIG. 4A. Finally, script 400A includes a “finalize” statement that DBMS 130 executes to handle negative entry markers for deleted objects. For example, a negative entry marker is shown in Tuesday overlay 452 for function F2, indicating that this database object has been deleted since the base schema layer was generated.

As shown in the illustrated embodiment, the base schema 450 layer of schema 402A includes three functions F1, F2, and F3. Tuesday overlay 452, generated by executing script 400A on schema 402A, includes an entry indicating that function F3 has been updated (modified), an entry indicating that function F4 has been added, and a negative entry (which may also be referred to as a tombstone entry) indicating that function F2 has been removed from schema 402A. In this way, an application (and its corresponding developer) will use almost the exact same script when creating a base schema or an overlay schema. While executing a script, the database will evaluate each statement against the base schema, and skip statements that match the base schema.

This enables the disclosed system to primarily execute statements for objects in a schema overlay that are different from the base schema. Such techniques advantageously allow a developer to make minor modifications to their script (e.g., update script 400A) and then deploy a new overlay schema without needing knowledge about the schema's prior contents. This, in turn, provides application developers with tools for versioning their code. By utilizing the disclosed schema layering, application developers can version their DDL code and deploy it to an overlay schema. The disclosed database system computes differentials so that only a minimal set of objects is stored in response to such changes.

Script 400B, in the illustrated embodiment, includes several separate commands to generate a “Wednesday” schema. DBMS 130 executes this script, after executing script 400A, on base schema 450 of schema 402A using schema layering techniques to generate a Wednesday overlay 454 for schema 402A. Because the changes made to Wednesday overlay 454 are executed relative to base schema 450, Wednesday overlay 454 does not include changes made in the Tuesday Overlay 452. Said another way, the Wednesday overlay 454 creates all objects that differ between its script and the script of the base schema 450, without regard for the Tuesday schema. In the illustrated embodiment, script 400B includes DDL statements to create four different functions F1, F2, F3, and F5 and finalize the Wednesday schema. Because several of the statements are the same as those made in the script to generate base schema 450, DBMS 130 ignores these statements. For example, function F1 already exists in base schema 450, so DBMS 130 does not execute the first statement in script 400B. DBMS 130 make this determination using the fingerprint table discussed in detail below with reference to FIGS. 4B and 4C. Similarly, function F2 is created in base schema 450, so the “CREATE F2” statement in script 400B is ignored, since this object already exists in base schema 450. However, DBMS 130 executes statement “CREATE F5” to add a function F5 to the Wednesday overlay 454 since this function does not exist in the base schema 450. Finally, DBMS 130 executes the FINALIZE SCHEMA WEDNESDAY statement to determine whether negative entries need to be added to Wednesday overlay 454 (no negative entries are added in this example).

As discussed in further detail below with reference to FIG. 4B, DBMS 130 executes an algorithm for computing schema differentials using a fingerprint table, such as fingerprint table 390. To efficiently compare the base schema layer with overlay schema layers and incoming requests for database changes (e.g., DDL statements), the disclosed system implements a fingerprint table, which stores a fingerprint of each database object that is created in a base or overlay schema layer. When executing the algorithm for implementing the fingerprint table, the disclosed system receives a DDL statement (from a script) that specifies to create a function F. The system first computes a statement hash and stores this statement hash in the fingerprint table (e.g., column 406 storing statement hash values in table 390 as shown in FIG. 4B). Next, the system determines if the function F1 specified in the statement needs to be created or if it already exists in the base schema. If the function needs to be created, the system creates the function in the function catalog table (e.g., function catalog table 380 as shown in FIG. 3). Finally, the system maintains a record of the dependency. For example, if a new function was created in the overlay, then the system creates a dependency from the fingerprint row to the new function (as shown in FIG. 4C) to the corresponding object in the base table. This dependency ensures that the fingerprint row in the fingerprint table will be deleted if the function it depends on is deleted. Said another way, if DBMS 130 were to execute a DDL statement such as CREATE FUNCTION F1 in a base or overlay schema, DBMS 130 would generate the following rows: a row in the function catalog table 380 (shown in FIG. 3) which stores the function itself, a row in the fingerprint table, and a row in a dependency catalog table that links the row in the functions catalog table for this function to the corresponding fingerprint row. Note that while the example DDL statements shown in FIG. 4A include only the name of the function, in various embodiments, DDL statements may include additional information. For example, a create function statement might include input parameters, return type, a body consisting of multiple lines of code, etc. While the dependency catalog table is not shown in FIG. 3, this table may be utilized by DBMS 130 to specify dependencies between various other system catalog tables, including fingerprint table 390.

The disclosed system may load schemas in various ways. In some embodiments, the disclosed database system loads schema using a DDL script to populate an empty schema and then computes the differential between the script and the base schema using the disclosed fingerprint table (discussed below with reference to FIG. 4B). In other embodiments, the disclosed database system reloads the schema using a DDL script to populate an old or non-empty schema and computes the differential between the script, the schema's current contents, and the base schema.

Turning now to FIG. 4B, a block diagram illustrating an example fingerprint table generated from the DDL scripts of FIG. 4A is shown. In the illustrated embodiments, DBMS 130 generates a fingerprint table 390 within system catalog 140, based on the example scripts 400A and 400B shown in FIG. 4A, to generate the base schema 450, Tuesday overlay 452, and Wednesday overlay 454, shown first in FIG. 4A and reproduced in FIG. 4B for ease of reference. In the illustrated embodiment, the rows of fingerprint table 390 are resolved by DBMS to generate the layers of schema 402A based on executing scripts 400A and 400B.

In the illustrated embodiment, fingerprint table 390 includes several columns: schema identifier (ID) 404, statement (stmt.) hash 405, existing object 408, object name 412, and object identifier (ID) 414. Each entry in fingerprint table 390 corresponds to a statement in one of scripts 400A and 400B. In the illustrated embodiment, DBMS 130 generates fingerprint table 390 by creating three entries for the three database objects included in the base schema 450 according to a base script (not shown). For example, the first entry of fingerprint table 390 includes a schema ID 404 of “Base,” a statement hash 406 of “999987,” an existing object ID 408 of “0,” an object name 412 of “F1,” and an object ID 414 of “20.” Similarly, the entries in fingerprint table 390 for functions F2 and F3 include unique statement hashes, object names, and object IDs, respectively. In various embodiments, the DBMS 130 generates statement hash 406 values to be stored in the statement hash 406 column based on text included in a command string (e.g., script statement) used to generate an object. For example, the statement hash generated for an added or updated object will be different than the statement hash for the original version of this object.

Next, in the illustrated embodiment, DMBS 130 adds four new rows to fingerprint table 390 in response to executing the Tuesday script 400A. For example, DBMS 130 adds a row to fingerprint table 390 for function F1, since script 400A includes a statement “CREATE F1.” Note, however, that this entry of fingerprint table 390 has been crossed out (e.g., removed), because when DBMS 130 performs the “FINALIZE SCHEMA TUESDAY” statement, the system identifies that this entry and the first entry corresponding to existing object ID 414 of “20” include the same statement hash 406. DBMS 130 identifies that function F1 already exists in base schema 450 and has not been altered by the Tuesday script 400A. Thus, DBMS 130 does not require an entry in fingerprint table 390 (or in the resulting Tuesday overlay 452 as shown in the bottom portion of FIG. 4B). DBMS generates a new row in fingerprint table 390 for function F3, since script 400A updates function F3 relative to the base schema. Accordingly, the second entry in fingerprint table 390 for the Tuesday script 400A includes a new statement hash 406 value for function F3 since this function has been updated and is not the same as the function F3 included in base schema 450. The second entry for the Tuesday script 400A will result in an updated database object for F3 within Tuesday overlay 452 as shown in the bottom portion of FIG. 4B. Since Tuesday script 400A omits the function, F2, the DMBS 130 will not initially create an entry for this function in the fingerprint table or function table. Instead, later during the “FINALIZE” stage, the DBMS 130 will recognize the omission of this function relative to the base table and add a negative entry in the Tuesday overlay 452 to indicate that the object F2 was deleted in the Tuesday version of schema 402A and add a corresponding entry in the fingerprint table for tracking purposes.

The disclosed techniques utilize hash functions to efficiently detect differences between object definitions. For example, because DDL statements can be long (especially for “CREATE FUNCTION” statements, which might include thousands of lines), hashing statements may advantageously speed up the process of detecting differences since the system does not have to compare two long strings of text. Rather, for each hashed statement in the base schema, the system computes its hash value once and then uses that value to compare against the hash of each overlay schema object. The disclosed system may utilize any of various types of hash functions. For example, when generating hashed statements, the disclosed system might use a 256-bit hash function, such as SHA256.

In addition to executing Tuesday script 400A, DBMS 130 executes Wednesday script 400B, which results in four new entries in fingerprint table 390. For example, the first entry corresponding to Wednesday script 400B is for function F1 according to the script 400B including a statement “CREATE F1.” This function, however, already exists in the first row of fingerprint table 390 since F1 was generated in base schema 450. Accordingly, DBMS 130 removes this entry from fingerprint table 390. Similarly, the second and third entries in fingerprint table 390 corresponding to Wednesday script 400B are for functions F2 and F3, which already exist in earlier rows or the fingerprint table 390, DBMS 130 removes these rows from the table. For the fourth entry corresponding to Wednesday script 400B, however, a new function F5 has been added according to the script 400B including the statement “CREATE F5.” This function does not exist in the earlier rows of fingerprint table 390 (because it does not exist in the base schema). Accordingly, DMBS 130 keeps this row in fingerprint table 390.

FIG. 4C is a block diagram illustrating an example function catalog table and layer catalog table corresponding to the fingerprint table of FIG. 4B. In the illustrated embodiment, arrows indicate the mappings between rows of fingerprint table 390 and rows of function catalog table 380. The rows of function catalog table 380 are generated by DBMS 130 as it generates fingerprint table 390. For example, the function objects stored in table 380 are generated by DBMS 130 when it executes the CREATE FUNCTION statements. When DMBS 130 executes the FINALIZE command, it cleans up unnecessary objects from the catalog and creates negative entries in the schemas. In the illustrated embodiment, function catalog table 380 includes a first row with a schema ID 404 of “Base” with the object name F1. As another example, the fourth row of function catalog table 380 includes a schema ID 404 of “Tuesday” and an object name 412 of “F3” indicating that the function F3 is included in the Tuesday overlay (and was likely modified in the Tuesday overlay). In some embodiments, the function catalog table 380 stores source code for various functions, as well as a return type and input parameter types. The function source code can be quite large.

As discussed above with reference to FIG. 1, in various embodiments, DBMS 130 refreshes a base schema layer periodically, e.g., every week, month, year, etc. For example, once DMBS 130 has made a threshold number of changes to a given schema via the overlay schema layers, these overlays may start to get large and include a more than a threshold number of changes. The large schema overlays may reduce the efficiency improvement of the schema layering, in general. Accordingly, DMBS 130 starts over with schema layering for the given schema by generating a new “base.” This new base is produced by DBMS 130 by combining the changes in a latest (newest) schema overlay with the current base layer to generate an updated base layer for this schema. This concept is shown at the bottom of FIG. 4C and is tracked by DBMS 130 via a layer catalog table 395.

In the illustrated embodiment, layer catalog table 395 includes two columns: a schema ID 402 column and a parent ID 418 column. The schema ID 402 values indicates a current schema layer and its corresponding parent base layer. The parent base layer of a schema overlay may either be the original base schema, referred to as the “super base” or may be a newer, replacement base schema. The multiple levels of layering performed by DBMS 130 are tracked within layer catalog table 395.

FIGS. 5A and 5B are block diagrams illustrating example implementation of database queries for application 120 according to different layers of schema 402A. In both FIGS. 5A and 5B, base schema 502 includes the following objects: view 512A, view 512B, view 512C, function 514A, and function 514B. The Monday schema 504A is empty (no changes were made on Monday, so this overlay does not differ from base schema 502). Second overlay 504B (i.e., the Tuesday overlay) includes a modified view 512B, an added view 512D, and a deleted function 514B. Further, third overlay 504C (i.e., the Wednesday overlay) includes a modified view 512B, a deleted function 514B, an added function 514C, and a modified view 512D.

In FIG. 5A, application 120 submits a database command 506A that includes unqualified object references to DBMS 130 to be executed on database 150. Database command 506A includes a query to select application data from view 512D stored in schema 402A. Because command 506A includes unqualified object references, DBMS 130 first searches in third overlay 504C (i.e., the Wednesday schema layer) according to a search path order. Based on this first search, DBMS 130 identifies that a modified view 512D exists in third overlay 504C. Accordingly, DBMS 130 accesses the modified version of view 512 included in schema overlay 504C. After retrieving the data stored in view 512D, DBMS 130 returns this data to application 120 via a response to the database command 506A submitted by application 120.

In FIG. 5B, application 120 submits a database command that includes qualified object references. Specifically, database command 506B specifies to select data from a view 512D that is stored in the Tuesday overlay 504B of schema 402A. In the illustrated embodiment, because command 506B specifies the Tuesday schema, DBMS 130 first searches in second overlay 504B for view 512D. In response to identifying new view 512D in second overlay 504B, DBMS 130 returns the application data stored in view 512D to application 120. Note that the responses sent by DBMS 130 to application 120 in FIGS. 5A and 5B will include different data (i.e., since the data stored in view 512D, which is stored in third overlay 504C, has been modified).

In some embodiments, the disclosed database system executes a DDL statement using the following syntax: CREATE IF NOT EXISTS EXACTLY. For example, this type of statement is a separate DDL statement from ordinary DDL statements in that this new type of DDL statement creates fingerprints and is used in the disclosed schema layering.

### Example Methods

Turning now to FIG. 6, a flow diagram illustrating a method 600 for handling application requests from a database implemented using schema layers, according to some embodiments. The method shown in FIG. 6 may be used in conjunction with any of the computer circuitry, systems, devices, elements, or components disclosed herein, among other devices. In various embodiments, some of the method elements shown may be performed concurrently, in a different order than shown, or may be omitted. In some embodiments, method 600 is performed by database management system 130 shown in FIG. 1 and discussed in detail above. Additional method elements may also be performed as desired.

At 610, in the illustrated embodiment, a database system maintains a database that stores application data for an application in a schema implemented using schema layering. In some embodiments, the database system maintains application data for a plurality of instances of the application. In some embodiments, the database system maintains multiple different base layers for various different schemas. In some embodiments, each of the multiple different base layers maintained by the database system includes its own plurality of schema overlays.

At 620, in the illustrated embodiment, the database system receives, from an instance of the application during the maintaining, a request to access application data stored in the database. In some embodiments, the request is a query that includes a qualified object reference indicating an order in which to access one or more database objects stored in the database. In some embodiments, the query includes a qualified object reference indicating a schema in which to access the plurality of schema layers when accessing the one or more database objects specified in the query. In some embodiments, the database system accesses catalog metadata (e.g., stored in system catalog 140) to determine links between each schema to its base schema (and each base schema to its base).

In some embodiments, the request is a query that specifies a data definition layer (DDL) script to execute on the database that stores application data for a plurality of instances of the application. In some embodiments, accessing the one or more database objects stored in the selected one or more of the plurality of schema layers includes altering the one or more database objects. For example, in some embodiments, the database system uses a DDL script to populate an empty schema and computes the differential between the script and the base schema of this empty schema. In other embodiments, the database system uses a DDL script to populate an old or non-empty schema and computes the differential between the script, the schema's current contents, and the base schema. In some embodiments, the DDL script specifies one or more of the following types of database operations for one or more of the database objects: create, update, and delete. For example, the scripts themselves for schema overlays may include only create statements, but the disclosed system would implicitly recognize when the creation or absence of creation represents one of a create, update, or delete relative to the base schema.

At 630, in the illustrated embodiment, the database system accesses one or more schema overlays prior to accessing a base schema layer of the schema implemented using schema layering, where recent versions of objects stored in the one or more schema overlays take precedence over prior versions of the objects stored in the base schema layer. In some embodiments, the one or more schema overlays and the schema base layer are different layers of the schema. In some embodiments, the different layers of the schema correspond to different versions of the application. In some embodiments, accessing the one or more schema overlays includes identifying, based on a negative entry included in the one or more schema overlays, that a database object specified in the request has been deleted, where the transmitting includes a notification indicating that the database object is unavailable.

At 640, in the illustrated embodiment, after accessing the one or more schema overlays, the database system accesses the base schema layer to retrieve one or more objects that are not included in the one or more overlay schema layers. In some embodiments, the database system receives, from a second, different instance of the application, a second request, where the second request includes a qualified object reference that indicates a schema to access for one or more database objects specified in the second request.

At 650, in the illustrated embodiment, the database system transmits, to the instance of the application, a notification indicating results of accessing the one or more database objects stored in the selected one or more of the plurality of schema layer. In some embodiments, the instance of the application is operating on a computing device that is executing a first version of the application corresponding to a first schema overlay of the schema, where the notification includes a set of objects retrieved from the first schema overlay.

In some embodiments, the database system receives, from a second, different instance of the application executing on a computing system, a second request, where the second request includes an unqualified object reference that does not specify a schema to access for one or more database objects specified in the second request. In some embodiments, in response to identifying that the second request includes an unqualified object reference, accessing, by the database system, the one or more schema overlays and the base schema layer in an order specified by a search path of the computing system from which the second request was received.

In some embodiments, the database system receives, from a second, different instance of the application executing on a second, different computing system, a second query specifying one or more database objects stored in the database, where the second, different instance is a different version of the application than the first instance of the application. In some embodiments, the second, different instance of the application requests application data stored in a different schema layer than the selected one or more of the plurality of schema layers accessed by the first instance of the application.

In some embodiments, the database system receives queries with unqualified references and the search path, but the base schema is not included in the search path. Such embodiments may advantageously be less error prone in situations in which an application uses schema layering with unqualified references, but forgets to include the base schema in the search path. In these situations, when an application adds an overlay to the search path, the disclosed system would automatically add the base schema to the search path such that the base is always searched right after the overlay.

Turning now to FIG. 7, a flow diagram illustrating a method 700 for handling application queries from a database implemented using schema layers, according to some embodiments. The method shown in FIG. 7 may be used in conjunction with any of the computer circuitry, systems, devices, elements, or components disclosed herein, among other devices. In various embodiments, some of the method elements shown may be performed concurrently, in a different order than shown, or may be omitted. In some embodiments, method 700 is performed by database management system 130 shown in FIG. 1 and discussed in detail above. Additional method elements may also be performed as desired.

At 710, in the illustrated embodiment, a computing system maintains a database that stores application data for an application in a schema implemented using schema layering. In some embodiments, the schema implemented using schema layering includes a base schema and one or more schema overlays.

At 720, in the illustrated embodiment, the computing system receives a request to alter a database schema storing a set of objects for the application. In some embodiments, the request specifies to delete one or more database objects. In some embodiments, the computing system represents the one or more deleted objects in a schema overlay using negative entries.

At 730, in the illustrated embodiment, in response to the request, the computing system loads a base schema layer of the database schema, where the base schema layer includes the set of objects for the application. In some embodiments, in response to the request and based on a plurality of statements included in the request, the computing system generates a fingerprint table, where the fingerprint table is stored in a system catalog of the database. In some embodiments, the fingerprint table includes a statement hash column storing statement hash values generated for respective objects specified in the plurality of statements, where the statement hash values are generated based on at least the type of operation specified in the plurality of statements. In some embodiments, the statement hash values are generated based on the exact text included in a corresponding DDL statement. For example, if a single line of a DDL statement for function F1 were changed in a schema overlay, then the statement hash for this statement would be different from the statement hash generated for this function in the base schema.

At 740, in the illustrated embodiment, in response to the request and based on one or more database statements included in the request to alter the database schema, the computing system generates a schema overlay for the database schema based on the set of objects included in the base schema layer, where the schema overlay includes a subset of the set of objects utilized by the application. In some embodiments, the subset of the set of objects included in the base schema layer includes one or more of: an altered version of the set of objects, a new object, and a deleted object. In some embodiments, the subset of the set of objects included in the schema overlay is a differential between the base schema layer and the schema overlay. For example, a schema overlay includes only the objects that differ from the schema overlay's base schema. Similarly, for a schema overlay, the fingerprint table includes entries only for the objects in the schema overlay that differ from the schema overlay's base schema.

In some embodiments, the schema overlay is a first schema overlay. In some embodiments, in response to the second request, the computing system loads a base schema layer of the database schema and generates a second schema overlay for the database schema based on the set of objects included in the base schema layer. In some embodiments, the generating is based on one or more database statements included in the second request to alter the database schema and the subset of the set of objects included in the first schema overlay. In some embodiments, the second schema overlay includes the subset of the set of objects included in the first schema overlay and one or more additional objects altered or added during the generating the second schema overlay

In addition to methods 600 and 700 and their variants, non-transitory, computer-readable media storing program instructions executable to implement such methods are also contemplated, along with systems configured to implement these methods.

### Exemplary Multi-Tenant Database System

Turning now to FIG. 8, an exemplary multi-tenant database system (MTS) 800 in which various techniques of the present disclosure can be implemented is shown—e.g., system 100 may be MTS 800. In FIG. 8, MTS 800 includes a database platform 810, an application platform 820, and a network interface 830 connected to a network 840. Also as shown, database platform 810 includes a data storage 812 and a set of database servers 814A-N that interact with data storage 812, and application platform 820 includes a set of application servers 822A-N having respective environments 824. In the illustrated embodiment, MTS 800 is connected to various user systems 850A-850N through network 840. The disclosed multi-tenant system is included for illustrative purposes and is not intended to limit the scope of the present disclosure. In other embodiments, techniques of this disclosure are implemented in non-multi-tenant environments such as client/server environments, cloud computing environments, clustered computers, etc.

MTS 800, in various embodiments, is a set of computer systems that together provide various services to users (alternatively referred to as “tenants”) that interact with MTS 800. In some embodiments, MTS 800 implements a customer relationship management (CRM) system that provides mechanism for tenants (e.g., companies, government bodies, etc.) to manage their relationships and interactions with customers and potential customers. For example, MTS 800 might enable tenants to store customer contact information (e.g., a customer's website, email address, telephone number, and social media data), identify opportunities, record service issues, and manage marketing campaigns. MTS 800 may also enable those tenants to identify how customers have been communicated with, what the customers have bought, when the customers last purchased items, and what the customers paid. To provide the services of a CRM system and/or other services, as shown, MTS 800 includes a database platform 810 and an application platform 820.

Database platform 810, in various embodiments, is a combination of hardware elements and software routines that implement database services for storing and managing data of MTS 800, including tenant data. As shown, database platform 810 includes data storage 812. Data storage 812, in various embodiments, includes a set of storage devices (e.g., solid state drives, hard disk drives, etc.) that are connected together on a network (e.g., a storage attached network (SAN)) and configured to redundantly store data to prevent data loss. In various embodiments, data storage 812 is used to implement a database (e.g., database 150) comprising a collection of information that is organized in a way that allows for access, storage, and manipulation of the information. Data storage 812 may implement a single database, a distributed database, a collection of distributed databases, a database with redundant online or offline backups or other redundancies, etc. As part of implementing the database, data storage 812 may store files (e.g., files or database extents) that include one or more database records having respective data payloads (e.g., values for fields of a database table) and metadata (e.g., a key value, timestamp, table identifier of the table associated with the record, tenant identifier of the tenant associated with the record, etc.).

In various embodiments, a database record may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 800 may store, in the same table, database records for one or more tenants—that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, the data stored at data storage 812 is organized as part of a log-structured merge-tree (LSM tree). An LSM tree normally includes two high-level components: an in-memory buffer and a persistent storage. In operation, a database server 814 may initially write database records into a local in-memory buffer before later flushing those records to the persistent storage (e.g., data storage 812). As part of flushing database records, the database server 814 may write the database records into new files that are included in a “top” level of the LSM tree. Over time, the database records may be rewritten by database servers 814 into new files included in lower levels as the database records are moved down the levels of the LSM tree. In various implementations, as database records age and are moved down the LSM tree, they are moved to slower and slower storage devices (e.g., from a solid state drive to a hard disk drive) of data storage 812.

When a database server 814 wishes to access a database record for a particular key, the database server 814 may traverse the different levels of the LSM tree for files that potentially include a database record for that particular key. If the database server 814 determines that a file may include a relevant database record, the database server 814 may fetch the file from data storage 812 into a memory of the database server 814. The database server 814 may then check the fetched file for a database record having the particular key. In various embodiments, database records are immutable once written to data storage 812. Accordingly, if the database server 814 wishes to modify the value of a row of a table (which may be identified from the accessed database record), the database server 814 writes out a new database record to the top level of the LSM tree. Over time, that database record is merged down the levels of the LSM tree. Accordingly, the LSM tree may store various database records for a database key where the older database records for that key are located in lower levels of the LSM tree then newer database records.

Database servers 814, in various embodiments, are hardware elements, software routines, or a combination thereof capable of providing database services, such as data storage, data retrieval, and/or data manipulation. Database 150 may be a database server that may correspond to a distributed storage system or one or more nodes of system 130. Such database services may be provided by database servers 814 to components (e.g., application servers 822) within MTS 800 and to components external to MTS 800. As an example, a database server 814 may receive a database transaction request from an application server 822 that is requesting data to be written to or read from data storage 812. The database transaction request may specify an SQL SELECT command to select one or more rows from one or more database tables. The contents of a row may be defined in a database record and thus database server 814 may locate and return one or more database records that correspond to the selected one or more table rows. In various cases, the database transaction request may instruct database server 814 to write one or more database records for the LSM tree—database servers 814 maintain the LSM tree implemented on database platform 810. In some embodiments, database servers 814 implement a relational database management system (RDMS) or object-oriented database management system (OODBMS) that facilitates storage and retrieval of information against data storage 812. In various cases, database servers 814 may communicate with each other to facilitate the processing of transactions. For example, database server 814A may communicate with database server 814N to determine if database server 814N has written a database record into its in-memory buffer for a particular key.

Application platform 820, in various embodiments, is a combination of hardware elements and software routines that implement and execute CRM software applications as well as provide related data, code, forms, web pages and other information to and from user systems 850 and store related data, objects, web page content, and other tenant information via database platform 810. To facilitate these services, in various embodiments, application platform 820 communicates with database platform 810 to store, access, and manipulate data. In some instances, application platform 820 may communicate with database platform 810 via different network connections. For example, one application server 822 may be coupled via a local area network and another application server 822 may be coupled via a direct network link. Transfer Control Protocol and Internet Protocol (TCP/IP) are exemplary protocols for communicating between application platform 820 and database platform 810, however, it will be apparent to those skilled in the art that other transport protocols may be used depending on the network interconnect used.

Application servers 822, in various embodiments, are hardware elements, software routines, or a combination thereof capable of providing services of application platform 820, including processing requests received from tenants of MTS 800. Application servers 822, in various embodiments, can spawn environments 824 that are usable for various purposes, such as providing functionality for developers to develop, execute, and manage applications (e.g., business logic). Data may be transferred into an environment 824 from another environment 824 and/or from database platform 810. In some cases, environments 824 cannot access data from other environments 824 unless such data is expressly shared. In some embodiments, multiple environments 824 can be associated with a single tenant.

Application platform 820 may provide user systems 850 access to multiple, different hosted (standard and/or custom) applications, including a CRM application and/or applications developed by tenants. In various embodiments, application platform 820 may manage creation of the applications, testing of the applications, storage of the applications into database objects at data storage 812, execution of the applications in an environment 824 (e.g., a virtual machine of a process space), or any combination thereof. In some embodiments, application platform 820 may add and remove application servers 822 from a server pool at any time for any reason, there may be no server affinity for a user and/or organization to a specific application server 822. In some embodiments, an interface system (not shown) implementing a load balancing function (e.g., an F5 Big-IP load balancer) is located between the application servers 822 and the user systems 850 and is configured to distribute requests to the application servers 822. In some embodiments, the load balancer uses a least connections algorithm to route user requests to the application servers 822. Other examples of load balancing algorithms, such as are round robin and observed response time, also can be used. For example, in certain embodiments, three consecutive requests from the same user could hit three different servers 822, and three requests from different users could hit the same server 822.

In some embodiments, MTS 800 provides security mechanisms, such as encryption, to keep each tenant's data separate unless the data is shared. If more than one server 814 or 822 is used, they may be located in close proximity to one another (e.g., in a server farm located in a single building or campus), or they may be distributed at locations remote from one another (e.g., one or more servers 814 located in city A and one or more servers 822 located in city B). Accordingly, MTS 800 may include one or more logically and/or physically connected servers distributed locally or across one or more geographic locations.

One or more users (e.g., via user systems 850) may interact with MTS 800 via network 840. User system 850 may correspond to, for example, a tenant of MTS 800, a provider (e.g., an administrator) of MTS 800, or a third party. Each user system 850 may be a desktop personal computer, workstation, laptop, PDA, cell phone, or any Wireless Access Protocol (WAP) enabled device or any other computing device capable of interfacing directly or indirectly to the Internet or other network connection. User system 850 may include dedicated hardware configured to interface with MTS 800 over network 840. User system 850 may execute a graphical user interface (GUI) corresponding to MTS 800, an HTTP client (e.g., a browsing program, such as Microsoft's Internet Explorer™ browser, Netscape's Navigator™ browser, Opera's browser, or a WAP-enabled browser in the case of a cell phone, PDA or other wireless device, or the like), or both, allowing a user (e.g., subscriber of a CRM system) of user system 850 to access, process, and view information and pages available to it from MTS 800 over network 840. Each user system 850 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 800 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 850 may be users in differing capacities, the capacity of a particular user system 850 might be determined one or more permission levels associated with the current user. For example, when a user is using a particular user system 850 to interact with MTS 800, that user system 850 may have capacities (e.g., user privileges) allotted to that user. But when an administrator is using the same user system 850 to interact with MTS 800, the user system 850 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 800 that are allocated at the tenant level while other data structures are managed at the user level.

In some embodiments, a user system 850 and its components are configurable using applications, such as a browser, that include computer code executable on one or more processing elements. Similarly, in some embodiments, MTS 800 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 840 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 850 may communicate with MTS 800 using TCP/IP and, at a higher network level, use other common Internet protocols to communicate, such as HTTP, FTP, AFS, WAP, etc. For example, where HTTP is used, user system 850 might include an HTTP client commonly referred to as a “browser” for sending and receiving HTTP messages from an HTTP server at MTS 800. Such a server might be implemented as the sole network interface between MTS 800 and network 840, but other techniques might be used as well or instead. In some implementations, the interface between MTS 800 and network 840 includes load sharing functionality, such as round-robin HTTP request distributors to balance loads and distribute incoming HTTP requests evenly over a plurality of servers.

In various embodiments, user systems 850 communicate with application servers 822 to request and update system-level and tenant-level data from MTS 800 that may require one or more queries to data storage 812. In some embodiments, MTS 800 automatically generates one or more SQL statements (the SQL query) designed to access the desired information. In some cases, user systems 850 may generate requests having a specific format corresponding to at least a portion of MTS 800. As an example, user systems 850 may request to move data objects into a particular environment 824 using an object notation that describes an object relationship mapping (e.g., a JavaScript object notation mapping) of the specified plurality of objects.

The various techniques described herein may be performed by one or more computer programs. The term “program” is to be construed broadly to cover a sequence of instructions in a programming language that a computing device can execute. Database management system 130, shown in FIG. 1, may also be referred to herein as a “computer system” and is one example of the computing device that may execute various sequences of instructions that make up a program. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” to facilitate execution of the program instructions by a computer system, such as database management system 130 or one or more computing systems 110A-110N. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. These phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system such as database management system 130) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to be “executable” to perform certain functionality, whether or not current software configuration parameters permit such execution. Executability means that when and if the instructions are executed, they perform the functionality in question.

The present disclosure refers to various software operations that are performed in the context of one or more computer systems. Database 150 can each execute on respective computer systems, for example. Similarly, system catalog 140 or database schema 160 can be implemented on the same computer system or different computer systems. For example, system catalog 140 and database tables 152A-N may be implemented by a first database management system (such as DBMS 130) and database schema 160 may be implemented by a second, different database system. Each of these components, then, is implemented on physical structure (i.e., on computer hardware).

In general, any of the services or functionalities of a software development environment described in this disclosure can be performed by a host computing device, which is any computer system, such as database management system 130, that is capable of connecting to a computer network. A given host computing device can be configured according to any known configuration of computer hardware. A typical hardware configuration includes a processor subsystem, memory, and one or more I/O devices coupled via an interconnect. For example, database management system 130 receives batch queries from one or more client computing devices via an interconnect corresponding to an I/O device of database management system 130 and stores data or metadata in a memory, such as system catalog 140 or database tables 152A-N as shown in FIG. 1. A given host computing device may also be implemented as two or more computer systems operating together.

The processor subsystem of the host computing device may include one or more processors or processing units. In some embodiments of the host computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the host computing device is usable to store program instructions executable by the processor subsystem to cause the host computing device to perform various operations described herein. The system memory may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read-only memory (PROM, EEPROM, etc.), and so on. Memory in the host computing device is not limited to primary storage. Rather, the host computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the host computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,”“an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of ... w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of ... w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
maintaining, by a database system, a database that stores application data for an application in a schema implemented using schema layering;
receiving, by the database system from an instance of the application during the maintaining, a request to access application data stored in the database;
accessing, by the database system, one or more schema overlays prior to accessing a base schema layer of the schema implemented using schema layering, wherein recent versions of objects stored in the one or more schema overlays take precedence over corresponding prior versions of the objects stored in the base schema layer;
after accessing the one or more schema overlays, accessing, by the database system, the base schema layer to retrieve one or more objects that are not included in the one or more schema overlays; and
transmitting, by the database system to the instance of the application, a notification indicating results of accessing the one or more objects stored in the one or more schema overlays and the base schema layer.

2. The method of claim 1, wherein the one or more schema overlays and the schema base layer are different layers of the schema, and wherein the different layers of the schema correspond to different versions of the application.

3. The method of claim 1, wherein the instance of the application is operating on a computing device that is executing a first version of the application corresponding to a first schema overlay of the schema, wherein the notification includes a set of objects retrieved from the first schema overlay.

4. The method of claim 1, wherein the request is a query that includes a qualified object reference indicating an order in which to access one or more database objects stored in the database.

5. The method of claim 1, wherein the request is a query that specifies a data definition layer (DDL) script to execute on the database that stores application data for a plurality of instances of the application, and wherein the DDL script specifies one or more of the following types of database operations for one or more of the objects: create, update, and delete.

6. The method of claim 1, wherein the accessing the one or more schema overlays includes identifying, based on a negative entry included in the one or more schema overlays, that a database object specified in the request has been deleted, and wherein the transmitting includes a notification indicating that the database object is unavailable.

7. The method of claim 1, further comprising:
receiving, by the database system from a second, different instance of the application executing on a computing system, a second request, wherein the second request includes an unqualified object reference that does not specify a schema to access for one or more database objects specified in the second request.

8. The method of claim 7, further comprising:
in response to identifying that the second request includes an unqualified object reference, accessing, by the database system, the one or more schema overlays and the base schema layer in an order specified by a search path of the computing system from which the second request was received.

9. A non-transitory computer-readable medium having instructions stored thereon that are capable of causing a computing system to implement operations comprising:
maintaining a database that stores application data for an application in a schema implemented using schema layering;
receiving a request to alter a database schema storing a set of objects for the application;
in response to the request:
loading a base schema layer of the database schema, wherein the base schema layer includes the set of objects for the application; and
generating, based on one or more database statements included in the request to alter the database schema, a schema overlay for the database schema based on the set of objects included in the base schema layer, wherein the schema overlay includes a subset of the set of objects utilized by the application.

10. The non-transitory computer-readable medium of claim 9, wherein the operations further comprise in response to the request:
generating, based on a plurality of statements included in the request, a fingerprint table, wherein the fingerprint table is stored in a system catalog of the database.

11. The non-transitory computing-readable medium of claim 10, wherein the fingerprint table includes a statement hash column storing statement hash values generated for respective objects specified in the plurality of statements, wherein the statement hash values are generated based on a type of operations specified in the plurality of statements.

12. The non-transitory computer-readable medium of claim 9, wherein the subset of the set of objects included in the base schema layer includes one or more of: an altered version of the set of objects, new object, and a deleted object.

13. The non-transitory computer-readable medium of claim 9, wherein the subset of the set of objects included in the schema overlay is a differential between the base schema layer and the schema overlay.

14. The non-transitory computer-readable medium of claim 10, wherein the schema overlay is a first schema overlay, and wherein the operations further comprise:
receiving a second request to alter the database schema storing the set of objects for the application;
in response to the second request:
loading the base schema layer of the database schema; and
generating a second schema overlay for the database schema based on the set of objects included in the base schema layer, wherein the generating is based on one or more database statements included in the second request to alter the database schema and the subset of the set of objects included in the first schema overlay, and wherein the second schema overlay includes the subset of the set of objects included in the first schema overlay and one or more additional objects altered or added during the generating the second schema overlay.

15. The non-transitory computer-readable medium of claim 10, wherein the request is a query that specifies a data definition layer (DDL) script to execute on the database that stores application data for a plurality of instances of the application, and wherein the DDL script specifies one or more of the following types of database operations for the set of objects: create, update, and delete.

16. A system, comprising:
at least one processor; and
a memory having instructions stored thereon that are executable by the at least one processor to cause the system to:
maintain a database that stores application data for a plurality of versions of an application in a plurality of schema layers, wherein the plurality of schema layers include one or more schema overlays and a base schema layer;
receive, from a first instance of the application executing a first version on a computing system during the maintaining, a query specifying one or more database objects;
select, based on the query, one or more of the plurality of schema layers to access;
access the one or more database objects stored in the selected one or more of the plurality of schema layers; and
transmit, to the first instance of the application, a notification indicating results of accessing the one or more database objects stored in the selected one or more of the plurality of schema layers.

17. The system of claim 16, wherein the query includes a qualified object reference indicating a schema in which to access the plurality of schema layers when accessing the one or more database objects specified in the query.

18. The system of claim 16, wherein the instructions are further executable by the at least one processor to cause the system to:
receive, from a second, different instance of the application executing on a second, different computing system, a second query specifying one or more database objects stored in the database, wherein the second, different instance is a different version of the application than the first instance of the application, and wherein the second, different instance of the application requests application data stored in a different schema layer than the selected one or more of the plurality of schema layers accessed by the first instance of the application.

19. The system of claim 16, further comprising:
receiving, from a second, different instance of the application, a second request, wherein the second request includes a qualified object reference that indicates a schema to access for one or more database objects specified in the second request.

20. The system of claim 16, wherein the query specifies a data definition layer (DDL) script to execute on the database that stores application data for a plurality of instances of the application, and wherein accessing the one or more database objects stored in the selected one or more of the plurality of schema layers includes altering the one or more database objects.
